(19) United States
(12) Patent Application Publication
(10) Pub. No.: US 2011/0093693 A1
(43) Pub. Date: Apr. 21, 2011

(54) BINDING A CRYPTOGRAPHIC MODULE TO A PLATFORM

(76) Inventors: Wael M. Ibrahim, Cypress, TX (US); E. David Neufeld, Magnolia, TX (US); Graeme John Proudler, Bristol (GB)

(21) Appl. No.: 12/935,552

(22) PCT Filed: Apr. 2, 2008
(86) PCT No.: PCT/US08/59093

§ 371 Date: Dec. 14, 2010

(51) Int. Cl. G06F 21/02; G06F 9/445

(52) U.S. Cl. 713/2; 726/34; 713/189

(57) ABSTRACT

One embodiment is a computer system having firmware that shares a secret with a cryptographic co-processor to determine if the cryptographic co-processor has been tampered with or removed from the computer system.

### BACKGROUND

Cryptographic co-processors perform several functions, such as generating encryption keys, storing secrets, encrypting data, decrypting data, signing data, and verifying signatures. Such processors are becoming increasingly important for computer security.

In order to provide a trust in computing, the Trusted Computing Group (TCG) developed a Trusted Platform Module (TPM) providing specifications for a secure cryptographic processor that can store secure information. TPM provides various functions, such as secure generation of cryptographic keys, remote attestation, sealed storage, binding, and a hardware random number generator.

The TCG specification requires a form of binding between the TPM and the mother board to which the TPM is attached. Soldering is one way to bind the TPM to the motherboard. This form of physical binding, however, restricts use of the TPM and poses supply chain issues for vendors and manufacturers.

### BRIEF DESCRIPTION OF THE DRAWINGS

FIG. 1 illustrates a flow diagram for initializing a TPM in accordance with an exemplary embodiment of the present invention.

FIG. 2 illustrates a tree diagram for adding a leaf key in accordance with an exemplary embodiment of the present invention.

FIG. 3 illustrates a flow diagram for verifying a TPM in accordance with an exemplary embodiment of the present invention.

FIG. 4 illustrates a computer system in accordance with an embodiment of the present invention.

### DETAILED DESCRIPTION

Exemplary embodiments in accordance with the present invention are directed to systems and methods for logically binding the Trusted Platform Module (TPM) to a platform, such as printed circuit board (PCB) through cryptographic methods. One embodiment enables the binding of a discrete TPM to a motherboard. A two-way binding is provided between the motherboard and the TPM. A shared secret between the TPM and the motherboard is used among other parameters to ensure the two-way binding.

Exemplary embodiments provide a binding between the TPM and the platform so the TPM can detect when it is being used on the wrong platform. Further, embodiments enable the platform to detect that the TPM is in the correct platform and to detect when the TPM has been removed and/or tampered with. Exemplary embodiments can be used with the TPM physically bound to the platform in a variety of ways, such as soldered to the platform or bound with a secure socket. Logically binding the TPM to a specific platform provides another security layer for the TPM and associated computing device.

In one embodiment, the TPM holds or stores a secret agreed upon with the firmware or Basic Input/Output System (BIOS). When the TPM starts, the BIOS checks or verifies whether the correct TPM is installed based on validity or correctness of the shared secret. Also, the TPM checks or verifies if the correct startup command has been sent with the correct authorization value. In one embodiment, this authorization value is the same as the sysAuth using the sysSRK key hierarchy. By way of example, such authorization is described in U.S. patent application having Ser. No. 11/493,972, entitled “Methods and Systems for Utilizing Cryptographic Functions of a Cryptographic Co-Processor” filed on Jul. 27, 2006, and being incorporated herein by reference.

If the TPM detects it has received a startup command with the wrong bindAuth, then TPM knows it is under attack and takes appropriate actions. These actions can include resetting the SRK, effectively resetting the TPM to manufacture default. The TPM will also set a flag (for example, an attack flag). As such, when the TPM is replaced in the original platform, the BIOS will know that the TPM has been tampered with, and can take appropriate measures that are defined by an organization policy.

One embodiment uses the sysSRK to hold a shared secret under its tree. The BIOS stores or maintains this secret as well. In one embodiment, the shared key is not confidential in the BIOS (meaning that the BIOS image can be dumped). Nevertheless, use of the shared secret adds another complication to the attacker. The attacker will now have to remove the hard drive, dump the BIOS, remove the TPM, and install the TPM in a system that will extend identical PCR measurements as the original system in order to be able to attack the system.

In one embodiment, the CPU serial number and the chipset along with special bus cycles are used. This way the TPM binding includes the CPU serial number. At the same time that serial number is kept confidential and is not used for violating privacy of a user.

Exemplary embodiments enable the TPM to be implemented on a daughter card. This eliminates the need to have two separate SKUs (i.e., Stock Keeping Units that function as unique identifiers) and removes the necessity of maintaining two separate BIOS trees. Exemplary embodiments further enable the TPM to be cleared after being inserted in the wrong platform and enable, vendors or manufacturers to ship computer systems to geographical regions having TPM sales restrictions. Furthermore, exemplary embodiments eliminate the cost of mechanical binding rivets used to physically bind the TPM to the platform. Exemplary embodiments further do not require complex coding in the BIOS or the TPM Firmware and enable the BIOS to detect when the TPM has been removed or tampered with.

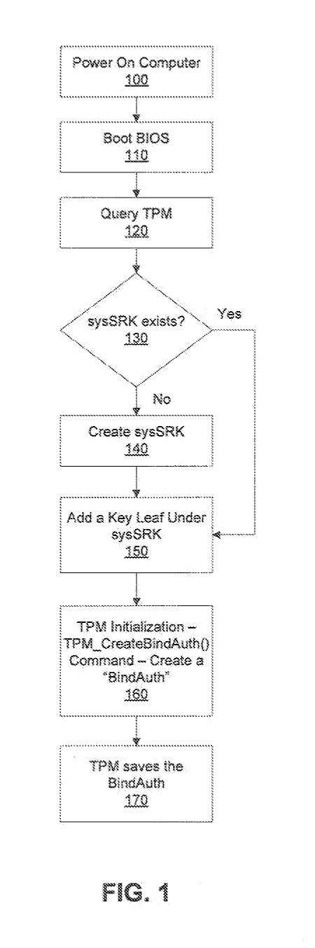

FIG. 1 illustrates a flow diagram for initializing a TPM in accordance with an exemplary embodiment of the present invention.

According to block 100, the computer is first powered on. During the power on, the BIOS boots according to block 110. The BIOS identifies hardware in the computer that includes the TPM. The TPM can be physically connected to the computer (for example, to the motherboard or other PCB) with soldering, a socket having a tamper resistant removal, or other form of physical binding.

According to block 120, the BIOS queries the TPM. For example, the BIOS sends a query to determine whether system SRK (sysSRK) already exists as shown in the block 130. If the answer to this question is “yes” then flow proceeds to block 150 where a leaf key is added under the sysSRK. If the answer to this question is “no” then flow proceeds to block 140 and the sysSRK is created.

After the leaf key is added, then flow proceeds to block 160 where the TPM is further initialized via a TPM_CreateBindAuth( ) command that creates a bindAuth, which is the secret shared value to be used with the modified TPM_Startup commands in subsequent boot cycles.

Flow then proceeds to block 170 where the BIOS saves the bindAuth created in block 160. Various mechanisms or techniques can be used to save the bindAuth.

During computerstartup, the BIOS issues a TPM_Init( ) command to initialize the TPM. On a personal computer (PC) this command arrives at the TPM via the LPC bus and informs the TPM that the platform is performing a boot process. TPM_Init puts the TPM into a state where it waits for the command TPM_Startup (which specifies the type of initialization that is required).

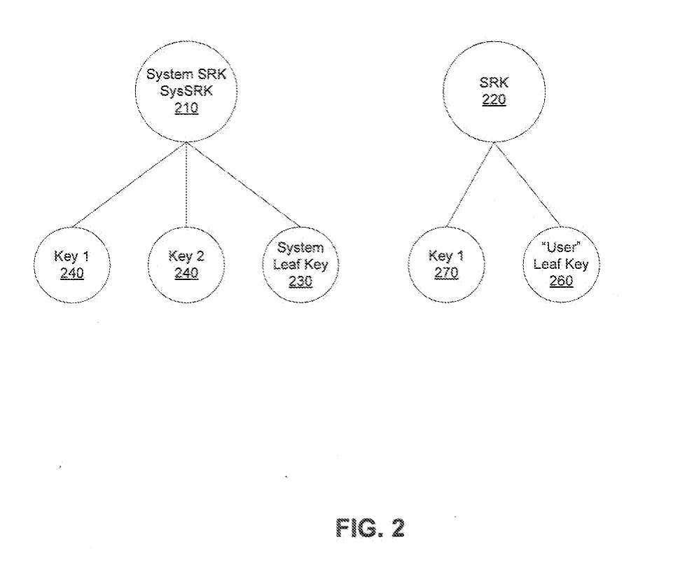

FIG. 2 shows a tree hierarchy of a storage root key (SRK) 220 and a System Storage Root key 210 residing on a TPM. In one exemplary embodiment, the SRK and the SysSRK are 2048 bit RSA keys that are at the top of the TPM key hierarchy.

The System Storage Root Key 210 further includes, by way of example, two keys 240 and the added System leaf key 230 per block 150 of FIG. 1. The Storage Root Key 220 (which already is part of the TCG specification) further includes, by way of example, key 270 or a “User” leaf key 260.

Each line between two objects represents the lower object being wrapped by the key of the object above it; its parent. In order to unwrap any of the auth data objects, the appropriate leaf key must be loaded. In one embodiment, the System leaf key 230 is generated in software in the TPM.

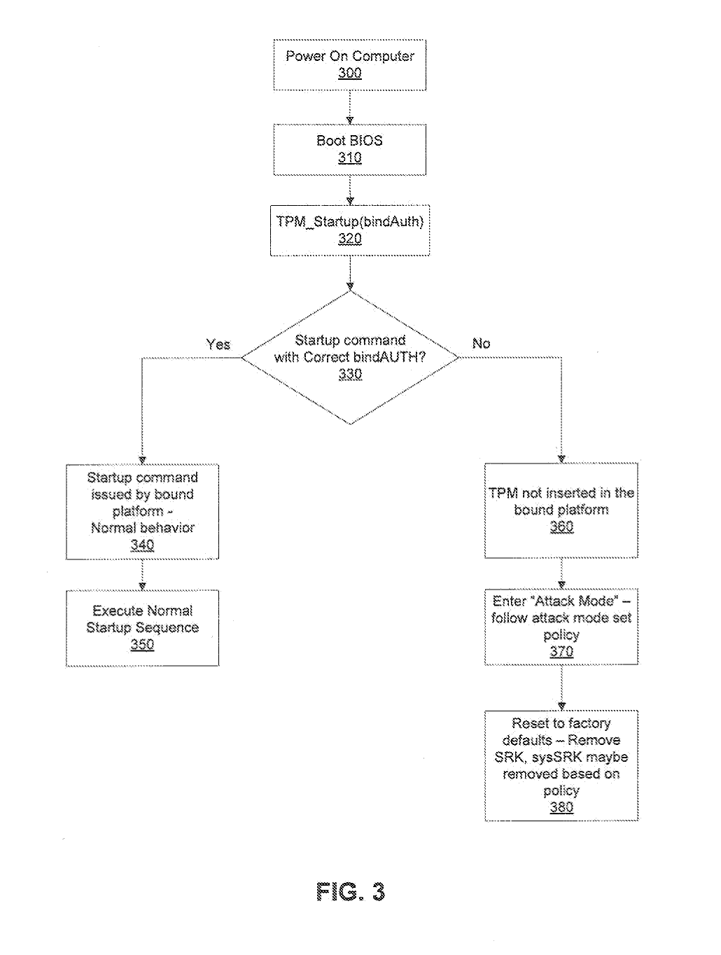

FIG. 3 illustrates a flow diagram for verifying a TPM in accordance with an exemplary embodiment of the present invention.

According to block 300, the computer is first powered on. During the power on, the BIOS boots according to block 310. The BIOS and TPM then begin a verification or validation process to determine if the correct TPM is installed and not compromised, for example, subject to a previous attack or installed on the correct platform.

According to block 320, the BIOS issues the TPM_Startup(bindAuth) to the TPM. According to block 330, the TPM determines if the TPM_Startup command came from an authenticated platform by checking the bindAuth parameter of the TPM_Startup command. If the answer to this question is “yes” then the TPM has verified that the platform is authentic (a bound platform) and flow and proceeds to block 340. Here, the startup command is issued by a bound platform and startup sequence proceeds normally according to block 350.

The TPM_Startup is a command that is available during the transition from the initial environment to a limited operational state. Startup transitions the TPM from the initialization state to an operational state. If the startup command does not include the correct authorization, then the TPM will not transition to the operational state. Naturally, if the TPM does not have an authorisation value, the TPM does not expect TPM_Startup to be authorized and the BIOS can go ahead with the binding stage where it creates a bindAuth used for sending an authorized TPM_Startup command on subsequent boot cycles.

If the answer to the question is “no” then the TPM has not received the command from a bound platform and flow proceeds to block 360. Here, the TPM is not inserted in the bound platform. By way of example, this situation would occur if the TPM was attacked, meaning it was removed from the “bound” platform and inserted in a new platform that does not know bindAuth. According to block 370, attack mode is entered since the TPM is not inserted in the valid platform.

Once in attack mode, one or more of various corrective or protective actions can occur as shown in block 380, such as resetting the TPM to factory defaults which clears the SRK and its hierarchy. For example, if the platform is not authenticated, then the TPM is cleared and returned to factory defaults. By way of example, the clearing process invalidates the SRK. Once invalidated, all information stored using the SRK is now unavailable. The invalidation does not change the blobs using the SRK rather there is no way to decrypt the blobs after invalidation of the SRK.

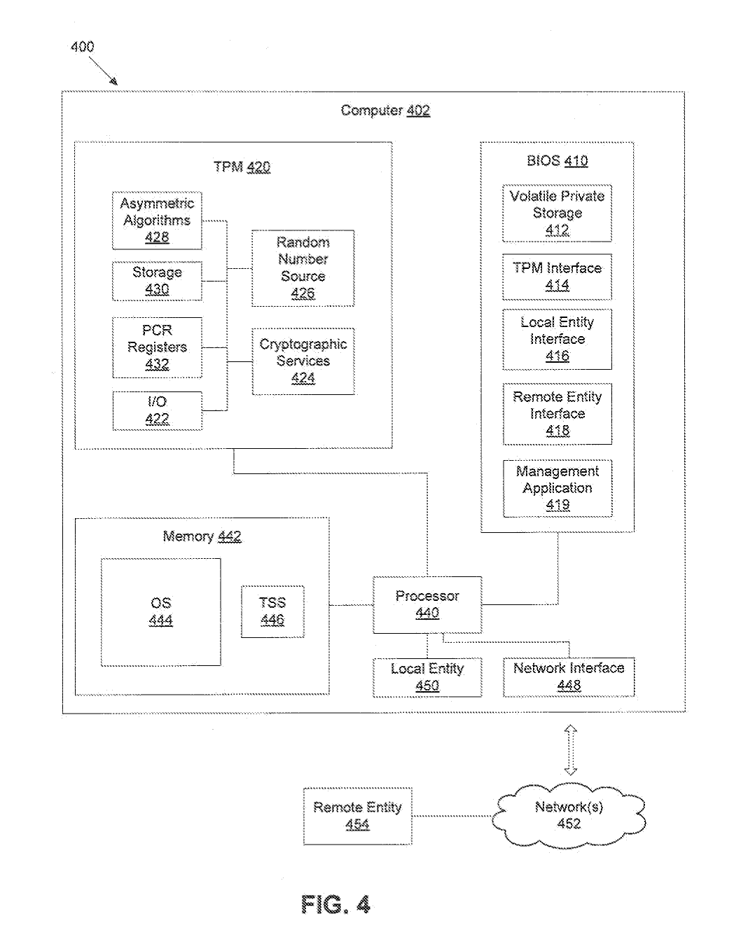

Embodiments in accordance with the present invention are utilized in or include a variety of systems, methods, and apparatus. FIG. 4 illustrates an exemplary embodiment as a computer system 400 for being or utilizing one or more of the computers, methods, flow diagrams and/or aspects of exemplary embodiments in accordance with the present invention.

Embodiments in accordance with the present invention are not limited to any particular type or number computer systems. The computer system, for example, includes various portable and non-portable computers and/or electronic devices. Exemplary computer systems include, but are not limited to, computers (portable and non-portable), servers, main frame computers, distributed computing devices, laptops, and other electronic devices and systems whether such devices and systems are portable or non-portable.

Embodiments of the invention enable platform entities such as a Basic Input/Output System (BIOS) system FW, or UEFI to selectively utilize the cryptographic functions of a cryptographic co-processor such as the Trusted Platform Module (TPM). For example, a platform BIOS may utilize the digital signature verification function of the TPM to ensure a BIOS flash image is authentic. Also, a platform BIOS may utilize the RSA algorithm of the TPM to wrap a symmetric key for securely exchanging the symmetric key between the BIOS and an operating system component. Also, a platform BIOS may utilize the symmetric key encryption and decryption of the TPM to securely encrypt and decrypt data transferred between the BIOS and an operating system. To ensure the TPM's cryptographic functions are accessible only to authorized entities, embodiments of the invention implement at least one authentication scheme. If a platform entity or a platform entity's command is successfully authenticated, the TPM's cryptographic functions are made available to the platform entity. If authentication fails, the TPM's cryptographic functions are not available to the platform entity. In at least some embodiments, different TPM functions are selectively available to different platform entities. Thus, after successful authentication, a platform entity may be authorized to utilize some TPM functions but not others.

As shown in FIG. 4, the system 400 comprises a computer 402 preferably coupled to at least one remote entity 454 via a network 452 The computer 402 may be, for example, a server, a desktop computer, a laptop computer or a mobile device. The computer 402 comprises a processor 440 coupled to at least one local entity 450. As used herein “local entities” refer to hardware/firmware/software entities that are internal to the computer 402 and “remote entities” refer to hardware/firmware/software entities that are external to the computer 402. Examples of local entities include but are not limited to an Operating System and peripherals such as a smartcard reader, a hard disk drive, network controller, and a graphics controller. Examples of remote entities include but are not limited to a server that provides BIOS upgrades or a peer computer that requests information regarding the BIOS's version.

As shown, the processor 440 couples to a network interface 448. The network interface 444 may take the form of modems, modem banks, Ethernet cards, Universal Serial Bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, or other network interfaces. Via the network interface 448, the processor 440 is able to connect to and communicate with the network 452 which may represent the Internet, Local Area Network (LANs) or Wide Area Network (WANs). With such a network connection, it is contemplated that the BIOS 410 (via the processor 440) might receive information from the network, or might output information to the network in the course of communicating with the remote entity 454.

As shown in FIG. 4, the processor 440 also has access to a Basic Input/Output System (BIOS) 410 which may be implemented, for example, as part of a chipset (e.g., a “Southbridge”) or other module. Exemplary embodiments enable the BIOS 410 (or another platform entity) to securely communicate with the local entity 450 and/or the remote entity 454.

The processor 440 also couples to a memory 442 which stores an operating system (OS) 444 for the computer 402. As shown, the memory 442 may also store a TCG Software Stack 446 (TSS) which handles requests sent to a Trusted Platform Module (TPM) 420 coupled to the processor 440.

The TPM 420 is configured to provide cryptographic functions such as an RSA asymmetric algorithm for digital signature and for encryption, SHA-1 hashing, a Hash-based Message Authentication Code (HMAC) function, secure storage, random number generation, or other functions. The TPM 420 is implemented using software, firmware and/or hardware. The TPM components shown in FIG. 4 have been generalized and are not all-inclusive. Also, TPM architectures and functions may, possibly change over time as authorized by the Trusted Computing Group (TCG).

As shown in FIG. 4, the TPM 420 comprises an input/output (I/O) interface 422 in communication with the processor 440. The I/O interface 422 couples to other TPM components such as cryptographic services 424, a random number source 426, asymmetric algorithms 428, storage 430 and Platform Configuration Registers (PCRs) 432. The cryptographic services 424 support functions such as hashing, digital signing, encryption and decryption. The random number source 426 generates random numbers for the cryptographic services 424. For example, in some embodiments, the cryptographic services 424 use random numbers to generate encryption keys. The asymmetric algorithms 428 enable the TPM 420 to perform asymmetric key operations. The storage 430 securely stores secrets (for example, encryption keys or other data) protected by the TPM 420. The PCRs 432 store information about the current state of the computer 402. For example, in some embodiments, the PCRs 432 store individual integrity measurements related to the computer 402 as well as sequences of integrity measurements.

The BIOS 410 comprises a-TPM interface 414 as well as a local entity interface 416 and a remote entity interface 418. The BIOS 410 also comprises a volatile private storage 412 which can be used to store secrets such as One-Time Pad (OTP) data and/or a secret shared with the TPM 420 while the computer is active but not after power is removed. As described herein, the TPM interface 414 enables secure communications between the BIOS 410 and the TPM 420, while the management application 419 enables non-secure communications between the BIOS 410 and the TPM 420.

In at least some embodiments, the TPM interface 414 includes a secured authentication scheme that, if successful, enables the BIOS 410 to selectively utilize cryptographic functions of the TPM 420 as well as non-volatile storage functions provided via the TPM 420. Upon successful authentication of the BIOS 410, the local entity interface 416 may utilize the cryptographic functions of the TPM 420 via the TPM interface 414 and the management application 419 to enable secure local communications between the BIOS 410 and the local entity 450. In at least some embodiments, the secure local communications are based on digital signatures (e.g., an RSA signature scheme). In other words, messages transferred between the BIOS 410 and the local entity 450 can be signed to indicate the source of the message. If a message transferred from the BIOS 410 to the local entity 450 (or vice versa) is not signed or the signature is invalid, the message is not trusted and is handled accordingly.

In at least some embodiments, storing BIOS secrets in non-volatile storage accessed via the TPM 420 involves a “sysSRK” storage key in the TPM 420. The sysSRK is congruent to the existing Storage Root Key (SRK). In at least some embodiments, the sysSRK is stored in the TPM's non-volatile secure memory and is the root of a separate System Protected Storage (SPS) architecture. The BIOS 410 also may create other keys in the separate SPS hierarchy or in the normal TPM protected storage hierarchy. In either case, the keys may be stored as encrypted blobs based on the TCG specification. The BIOS 410 may store the encrypted blobs in any convenient memory location depending on specific requirements such as access to that location during specific periods of a boot cycle of a platform (for example, access early in a boot cycle may be desired). In at least some embodiments, the sysSRK is available to the computer 402 regardless of whether the TPM 420 is owned, activated or enabled. With the sysSRK, the BIOS 410 can build a SPS hierarchy and store encrypted data with various types of access control. For example, a cryptographic HMAC challenge could be built using passwords, PCR registers and locality.

The BIOS 410 could include a flag or data structure that indicates when there is no need to create a new sysSRK. For example, the flag may be asserted if a sysSRK was created in a previous boot cycle. To create a new sysSRK, the BIOS 410 sends a sysSRK creation command to the TPM 420. The sysSRK creation command can be authenticated by the TPM 420 based on the sysAuth value and/or locality. In either case, authorization protocols for the new sysSRK key are based on the sysAuth value.

### DEFINITIONS

As used herein and in the claims, the following words have the following definitions:

The terms “automated” or “automatically” (and like variations thereof) mean controlled operation of an apparatus, system, and/or process using computers and/or mechanical/electrical devices without the necessity of human intervention, observation, effort and/or decision.

As used herein, “attestation” is the process of vouching for the accuracy of information. For example, external entities can attest to shielded locations, protected capabilities, and Roots of Trust. A platform can attest to its description of platform characteristics that affect the integrity (trustworthiness) of a platform. Both forms of attestation require reliable evidence of the attesting entity.

As used herein, a “blob” is encrypted data that is generated by a TPM (for use in Protected Storage, or for saving context outside the TPM).

As used herein, “BIOS” means firmware code executed by a computer when first powered on and functions to identify and initiate component hardware (such as hard drives, floppies, CDs, TPM, etc). During booting, the BIOS prepares the computer so other software programs stored on various media can load, execute, and assume control of the computer. The BIOS can also be a coded program embedded on a chip that recognizes and controls various devices that make up the computer.

As used herein, “firmware” is a computer program that is embedded in a hardware device, such as a microcontroller, or provided on flash ROMs or as a binary image file that can be uploaded onto existing hardware by a user.

As used herein, “platform” is a collection of resources that provides a service.

As used herein, “SRK” or “Storage Root Key” is a root key of a hierarchy of keys associated with a TPM's Protected Storage function; a non-migratable key generated within a TPM.

As used herein, “TPM” or “Trusted Platform Module” is a cryptographic processor implemented in accordance with the specifications defined in the TCG Trusted Platform Module Specification. TPM provides various functions, such as secure generation of cryptographic keys, remote attestation, sealed storage, binding, and a hardware'random number generator.

In one exemplary embodiment, one or more blocks or steps discussed herein are automated. In other words, apparatus, systems, and methods occur automatically.

The methods in accordance with exemplary embodiments of the present invention are provided as examples and should not be construed to limit other embodiments within the scope of the invention. For instance, blocks in flow diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A computer platform, comprising:
a processor;
a cryptographic co-processor coupled to the processor; and
a Basic Input/Output System (BIOS) coupled to the processor to establish a secure relationship with the cryptographic co-processor and determine if the cryptographic co-processor has been tampered with or removed from the computer platform.

2) The computer platform of claim 1, wherein the cryptographic co-processor is logically two-way bound to the computer platform, and the cryptographic co-processor stores a shared secret agreed upon by the BIOS.

3) The computer platform of claim 1, wherein when the cryptographic co-processor starts, the BIOS checks a TPM flag to detect whether the cryptographic co-processor has been tampered with or removed from the computer platform.

4) The computer platform of claim 1, wherein the cryptographic co-processor determines if a correct startup command is sent from the BIOS with a correct authorization value.

5) The computer platform of claim 1, wherein the cryptographic co-processor determines a security attack is occurring when the cryptographic co-processor receives a startup command from the BIOS with an incorrect bindAuth value that is used to control resources in the cryptographic co-processor.

6) The computer platform of claim 1, wherein the cryptographic co-processor is reset to manufacturer defaults when the cryptographic co-processor has been tampered with or removed from the computer platform.

7) The computer platform of claim 1, wherein the BIOS issues a startup command to the cryptographic co-processor to authenticate the computer platform, the startup command transitioning the computer platform from an initial environment to a limited operational state if the cryptographic co-processor verifies that the startup command contains a correct authorization.

8) A tangible computer readable storage medium having instructions for causing a computer to execute a method, comprising:
establishing a shared secret between a cryptographic co-processor and firmware in a computer platform to bind the cryptographic co-processor to the computer platform and determine when the cryptographic co-processor has been tampered with or removed from the computer platform.

9) The tangible computer readable storage medium of claim 8 further comprising, setting a flag to indicate that the cryptographic co-processor was removed from the computer platform or tampered with.

10) The tangible computer readable storage medium of claim 8 further comprising, clearing the cryptographic co-processor when the cryptographic co-processor is inserted into an incorrect computer platform.

11) The tangible computer readable storage medium of claim 8 further comprising, using a Basic Input/Output System (BIOS) to detect when the cryptographic co-processor is removed from the computer platform or tampered with.

12) The tangible computer readable storage medium of claim 8 further comprising, using symmetric key encryption and decryption provided by the cryptographic co-processor to allow both physical binding and cryptographic binding between a Trusted Platform Module (TPM) and the computer platform.

13) The tangible computer readable storage medium of claim 8 further comprising, providing the shared secret to a Basic Input/Output System (BIOS) in the computer platform to determine whether the cryptographic co-processor has been tampered with or removed from the computer platform.

14) The tangible computer readable storage medium of claim 8 further comprising, determining if a correct command during startup of the cryptographic co-processor is sent from the firmware to the cryptographic co-processor with a correct authorization value.

15) The tangible computer readable storage medium of claim 8 further comprising, restoring the cryptographic co-processor to defaults upon detecting that the cryptographic co-processor has been tampered with or removed from the computer platform.

16) A computer system, comprising:
a processor;
a cryptographic co-processor coupled to the processor; and
firmware coupled to the processor to share a secret with the cryptographic co-processor to bind the cryptographic co-processor with the computer system and determine if the cryptographic co-processor has been tampered with or removed from the computer system.

17) The computer system of claim 16, wherein the cryptographic co-processor is Trusted Platform Module (TPM).

18) The computer system of claim 16, wherein the cryptographic co-processor stores a key leaf under a system Storage Root Key (sysSRK) during a boot cycle that enables the firmware to detect when the cryptographic co-processor has been tampered with or removed from the computer system.

19) The computer system of claim 16, wherein the secret establishes a mutually secure relationship between the firmware and the cryptographic co-processor and verifies to the firmware that the cryptographic co-processor has not been tampered with or removed from the computer system.

20) The computer system of claim 16 wherein, the cryptographic co-processor provides cryptographic functions to the computer system after a a Basic Input/Output System (BIOS) in the computer system determines whether the cryptographic co-processor has been tampered with or removed from the computer system.
